(19) United States
(12) Patent Application Publication
(10) Pub. No.: US 2025/0384651 A1
(43) Pub. Date: Dec. 18, 2025

(54) SYSTEMS AND TECHNIQUES FOR SEGMENTING IMAGE DATA

(71) Applicant: QUALCOMM Incorporated, San Diego, CA (US)

(72) Inventors: Eyasu Zemene MEQUANINT, San Diego, CA (US); Yingyong QI, San Diego, CA (US); Ning BI, San Diego, CA (US)

(21) Appl. No.: 18/743,898

(22) Filed: Jun. 14, 2024

(51) Int. Cl. G06V 10/26; G06V 10/74; G06V 10/77; G06V 10/771; G06V 10/82

(52) U.S. Cl. CPC G06V 10/26; G06V 10/761; G06V 10/771; G06V 10/7715; G06V 10/82

(57) ABSTRACT

Systems and techniques are described herein for segmenting images. For instance, a method for segmenting images is provided. The method may include encoding, using a machine-learning-model image encoder, an image to generate a plurality of image features; selecting a first image feature from among the plurality of image features; determining a first image point related to the first image feature; encoding, using a machine-learning-model prompt encoder, the first image point as a first encoded prompt; generating, using a machine-learning-model image decoder, a first mask based on the plurality of image features and the first encoded prompt, wherein the first mask is indicative of pixels of the image that are semantically similar to the first image point; and storing the first mask.

### TECHNICAL FIELD

The present disclosure generally relates to segmenting image data. For example, aspects of the present disclosure include systems and techniques for labeling pixels of image data.

### BACKGROUND

Semantic segmentation is a computer-vision task which aims to associate each pixel of an image with an object or class label. For example, a segmenter may be provided with an image. The segmenter may generate a segmentation mask including a label for each pixel of the image.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Systems and techniques are described for segmenting images. According to at least one example, a method is provided for segmenting images. The method includes: encoding, using a machine-learning-model image encoder, an image to generate a plurality of image features; selecting a first image feature from among the plurality of image features; determining a first image point related to the first image feature; encoding, using a machine-learning-model prompt encoder, the first image point as a first encoded prompt; generating, using a machine-learning-model image decoder, a first mask based on the plurality of image features and the first encoded prompt, wherein the first mask is indicative of pixels of the image that are semantically similar to the first image point; and storing the first mask.

In another example, an apparatus for segmenting images is provided that includes at least one memory and at least one processor (e.g., configured in circuitry) coupled to the at least one memory. The at least one processor configured to: encode, using a machine-learning-model image encoder, an image to generate a plurality of image features; select a first image feature from among the plurality of image features; determine a first image point related to the first image feature; encode, using a machine-learning-model prompt encoder, the first image point as a first encoded prompt; generate, using a machine-learning-model image decoder, a first mask based on the plurality of image features and the first encoded prompt, wherein the first mask is indicative of pixels of the image that are semantically similar to the first image point; and store the first mask.

In another example, a non-transitory computer-readable medium is provided that has stored thereon instructions that, when executed by one or more processors, cause the one or more processors to: encode, using a machine-learning-model image encoder, an image to generate a plurality of image features; select a first image feature from among the plurality of image features; determine a first image point related to the first image feature; encode, using a machine-learning-model prompt encoder, the first image point as a first encoded prompt; generate, using a machine-learning-model image decoder, a first mask based on the plurality of image features and the first encoded prompt, wherein the first mask is indicative of pixels of the image that are semantically similar to the first image point; and store the first mask.

In another example, an apparatus for segmenting images is provided. The apparatus includes: means for encoding, using a machine-learning-model image encoder, an image to generate a plurality of image features; means for selecting a first image feature from among the plurality of image features; means for determining a first image point related to the first image feature; means for encoding, using a machine-learning-model prompt encoder, the first image point as a first encoded prompt; means for generating, using a machine-learning-model image decoder, a first mask based on the plurality of image features and the first encoded prompt, wherein the first mask is indicative of pixels of the image that are semantically similar to the first image point; and means for storing the first mask.

In some aspects, one or more of the apparatuses described herein is, can be part of, or can include an extended reality device (e.g., a virtual reality (VR) device, an augmented reality (AR) device, or a mixed reality (MR) device), a vehicle (or a computing device, system, or component of a vehicle), a mobile device (e.g., a mobile telephone or so-called “smart phone”, a tablet computer, or other type of mobile device), a smart or connected device (e.g., an Internet-of-Things (IoT) device), a wearable device, a personal computer, a laptop computer, a video server, a television (e.g., a network-connected television), a robotics device or system, or other device. In some aspects, each apparatus can include an image sensor (e.g., a camera) or multiple image sensors (e.g., multiple cameras) for capturing one or more images. In some aspects, each apparatus can include one or more displays for displaying one or more images, notifications, and/or other displayable data. In some aspects, each apparatus can include one or more speakers, one or more light-emitting devices, and/or one or more microphones. In some aspects, each apparatus can include one or more sensors. In some cases, the one or more sensors can be used for determining a location of the apparatuses, a state of the apparatuses (e.g., a tracking state, an operating state, a temperature, a humidity level, and/or other state), and/or for other purposes.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative examples of the present application are described in detail below with reference to the following figures:

FIG. 1 is a diagram illustrating an example system for segmenting image data;

FIG. 2A is a diagram illustrating an example system for segmenting image data, according to various aspects of the present disclosure;

FIG. 2B is a diagram including example images to illustrate example operations of the example system of FIG. 2A, according to various aspects of the present disclosure;

FIG. 2C is another diagram including example images to illustrate example operations of the example system of FIG. 2A, according to various aspects of the present disclosure;

FIG. 3 is a block diagram illustrating an example implementation of the selector of FIG. 2A, FIG. 2B, and FIG. 2C, according to various aspects of the present disclosure;

FIG. 4 is a flow diagram illustrating an example process for segmenting image data, in accordance with aspects of the present disclosure;

FIG. 5A is a flow diagram illustrating an example process for segmenting image data, in accordance with aspects of the present disclosure;

FIG. 5B is a flow diagram illustrating an example process for segmenting image data, in accordance with aspects of the present disclosure;

FIG. 6 is a block diagram illustrating an example of a deep learning neural network that can be used to perform various tasks, according to some aspects of the disclosed technology;

FIG. 7 is a block diagram illustrating an example of a convolutional neural network (CNN), according to various aspects of the present disclosure; and

FIG. 8 is a block diagram illustrating an example computing-device architecture of an example computing device which can implement the various techniques described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the exemplary aspects will provide those skilled in the art with an enabling description for implementing an exemplary aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage, or mode of operation.

Semantic segmentation is a computer-vision task which aims to associate each pixel of an image with an object or class label. The Segment Anything Model (SAM) (developed by Alexander Kirillov, Eric Mintun, Nikhila Ravi, Hanzi Mao, Chloe Rolland, Laura Gustafson, Tete Xiao, Spencer Whitehead, Alexander C. Berg, Wan-Yen Lo, Piotr Dollar, and Ross Girshick in 2023) is an example of a segmentation model. See “Segment Anything” Meta AI Research, FAIR (2023). SAM can perform various computer-vision tasks, such as image segmentation, captioning, and editing. However, the integration of SAM into industrial processes faces hurdles due to the high computational requirements of SAM, especially when SAM is to be used at the edge.

SAM may involve an interactive segmentation approach. For example, SAM may obtain an image and a prompt, and generate a mask based on the prompt. In some aspects, the term “mask” may refer to an indication of pixels of an image that are associated with a label. For instance, SAM may receive in image coordinate as a prompt. SAM may generate a mask of points, including the image coordinate, that are associated with the same label as the image coordinate. For instance, SAM may obtain an image of several people. SAM may also obtain an image coordinate corresponding to a face of one of the people. SAM may generate a mask indicating all the pixels representative of the face of the person.

In the segment-anything mode, SAM may generate masks based on a grid structure and generate a map based on the masks. For example, SAM may generate 1024 prompts based on a 32×32 grid of points (e.g., image coordinates). SAM may use the 1024 prompts, one at a time, to generate 1024 masks. SAM may then accumulate the masks into a map including labels for each pixel in the image. In the present disclosure, the term “accumulate” may refer to combining data. For example, accumulating masks may refer to combining a mask with one or more previously-accumulated masks. Each of the masks may be indicative of pixels associated with a label. The accumulated masks may be indicative of labels for many pixels of an image, based on the accumulated masks including several masks associated with respective labels. Accumulated masks may be referred to as a “map.” Some maps (e.g., complete maps) may include a label or association for each pixel of an image. To generate a segmentation map of an image, SAM may use a decoder to perform 1024 iterations of decoding images features based on 1024 prompts. For larger grid sizes, like 64×64, this process involves 4096 iterations.

Systems, apparatuses, methods (also referred to as processes), and computer-readable media (collectively referred to herein as “systems and techniques”) are described herein for segmenting images. For example, the systems and techniques described herein may encode, using a machine-learning-model image encoder, an image to generate a plurality of image features. The systems and techniques may determine a respective image point related to each of the plurality of image features. Further, the systems and techniques may encode, using a machine-learning-model prompt encoder, each image point as a respective encoded prompt. The systems and techniques May generate, using a machine-learning-model image decoder, a respective mask based on the plurality of image features and each of the respective encoded prompts. Each of the respective masks may be indicative of pixels of the image that are semantically similar to an image point. The systems and techniques may store each of the masks. Further the systems and techniques may accumulate each of the masks to generate a segmentation map of the image.

For example, the systems and techniques may encode an image to generate image features. Further, the systems and techniques may iteratively determine a prompt point for each of the image features. The prompt points may be determined based on an affinity matrix derived based on the image features. The affinity matrix may indicate the similarity between image features. The affinity matrix may identify groups or clusters of features with high similarity one to another. A point that closely resembles most of the other members within each cluster or group may be identified as a prompt point for the cluster or group. For example, for each image feature, the point that maximizes the mean similarity of the affinity matrix may be selected as the prompt point for the image feature.

Once a prompt point is identified for each of the image features, the systems and techniques may map the prompt points back to the original image (e.g., as image coordinates). The systems and techniques then encode the prompt points. The systems and techniques may decode the image features using the encoded prompt points (e.g., one at a time) to generate masks. Each of the mask may be indicative of pixels of the image that are semantically similar to a respective one of the prompt points. In each iteration of the process (e.g., for each image feature), another feature is selected to differ from any previously-selected feature to avoid redundancy. This iterative process continues until all pixels are segmented (e.g., associated with a map).

Various aspects of the application will be described with respect to the figures below.

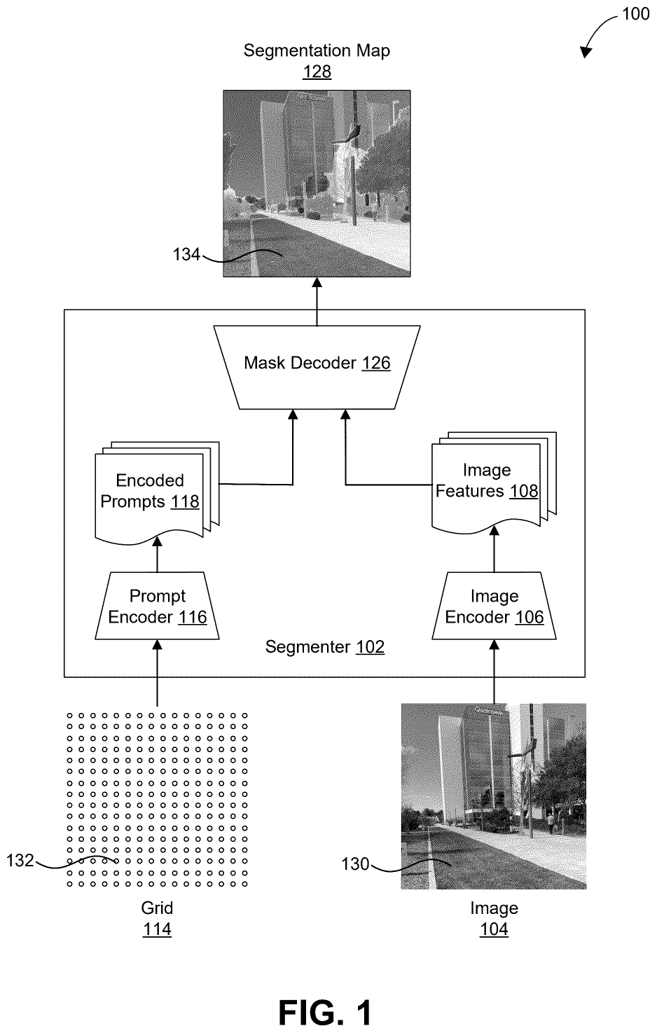

FIG. 1 is a diagram illustrating an example system 100 for segmenting image data. For example, a segmenter 102 of system 100 may generate a segmentation map 128 that may segment an image 104. For instance, segmentation map 128 may include a label for each pixel of image 104. The labels are illustrated as different shades of gray in segmentation map 128.

Segmenter 102 may be, or may include, one or more machine-learning models trained to segment images through an iterative supervised and/or semi-supervised learning process. The machine-learning models may be trained together, for example, in an end-to-end training process. Additionally or alternatively, one or more of the models may be trained independent of the others. As an example of end-to-end training, segmenter 102 may be provided with an image of a training data set. Segmenter 102 may generate segmentation map based on the image. A loss calculator may compare the segmentation map generated by segmenter 102 with a segmentation map included in the training data set. The loss calculator may determine a loss based on differences the segmentation map generated by segmenter 102 with a segmentation map included in the training data set. An adjuster may adjust parameters (e.g., weights of various machine-learning models of segmenter 102) such that in future iterations of the training process, the segmentation map generated by segmenter 102 is more similar to the segmentation of the training data set (e.g., according to a gradient descent technique). The process may be repeated any number of times with any number of training images and segmentation maps. Segmenter 102 may be an example of a segment anything model (SAM). Once trained, segmenter 102 may segment image 104 to generate segmentation map 128.

Image encoder 106 of segmenter 102 may generate image features 108 based on image 104. Image features 108 may include any number of dimensions. For example, image features 108 may have dimensions of 32×32×N or 64×64×N. Image features 108 may represent image 104 in a latent-feature space.

Prompt encoder 116 may encode (e.g., one at a time) points of grid 114 as respective encoded prompts of encoded prompts 118. Grid 114 may be, or may include, image coordinates. The image coordinates may be distributed (e.g., evenly) across the dimensions of image 104. Grid 114 may include any number of points. Prompt encoder 116 may generate encoded prompts 118 as latent-feature representations of points of grid 114.

Mask decoder 126 may decode image features 108 using each of encoded prompts 118 separately. For example, mask decoder 126 may decode image features 108 using a first of encoded prompts 118 to generate a first mask. The first mask may indicate pixels of image 104 that are semantically similar to the pixel of the image coordinate that corresponds to the first of encoded prompts 118.

Next, mask decoder 126 may decode image features 108 using a second of encoded prompts 118 to generate a second mask. The second mask may indicate pixels of image 104 that are semantically similar to the pixel of the image coordinate that corresponds to the second of encoded prompts 118. Segmenter 102 may decode image features 108 using each of encoded prompts 118 separately and accumulate the masks to generate segmentation map 128.

As an example, a pixel 130 of image 104 may relate to a point 132 of grid 114. For example, the image coordinates of pixel 130 may be closest to point 132 in grid 114. Prompt encoder 116 May generate an encoded prompt based on point 132. Mask decoder 126 may decode image features 108 using the encoded prompt based on point 132 to generate mask 134.

Other points of grid 114 that are close to point 132 may result in substantially the same mask as mask 134. For example, points of grid 114 that are near point 132 may relate to semantically similar pixels of image 104. Thus, mask decoder 126 may generate substantially similar masks based on points of grid 114 that are near point 132. For instance, image 104 includes many pixels representing grass. The pixels may all be semantically similar based on the pixels all representing grass. Many points of grid 114 may relate to the pixels that represent grass. Mask decoder 126 may generate substantially the same mask for all the points of grid 114 that relate to pixels of image 104 that represent grass.

Generating substantially the same mask multiple times may be a waste of computational resources (e.g., time and power). For example, generating a mask indicative of pixels that represent grass for each point of grid 114 that relates to pixels that represent grass may be wasteful.

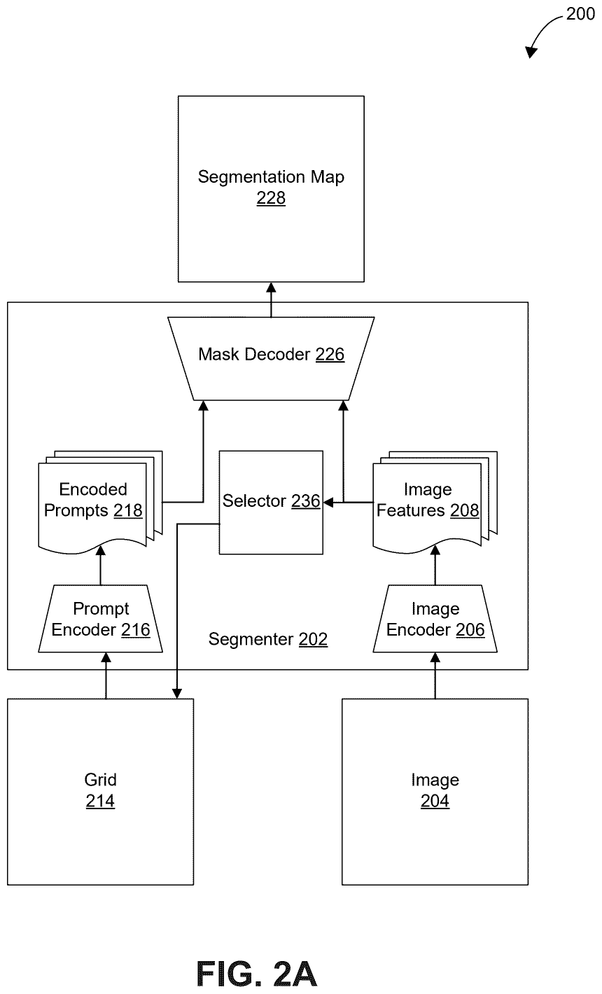

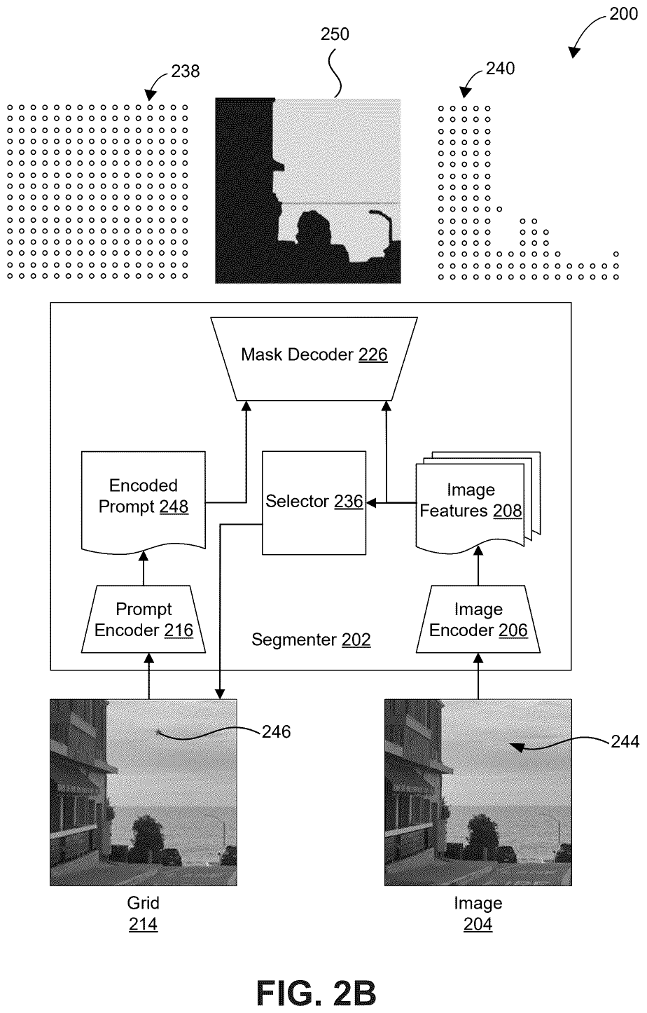

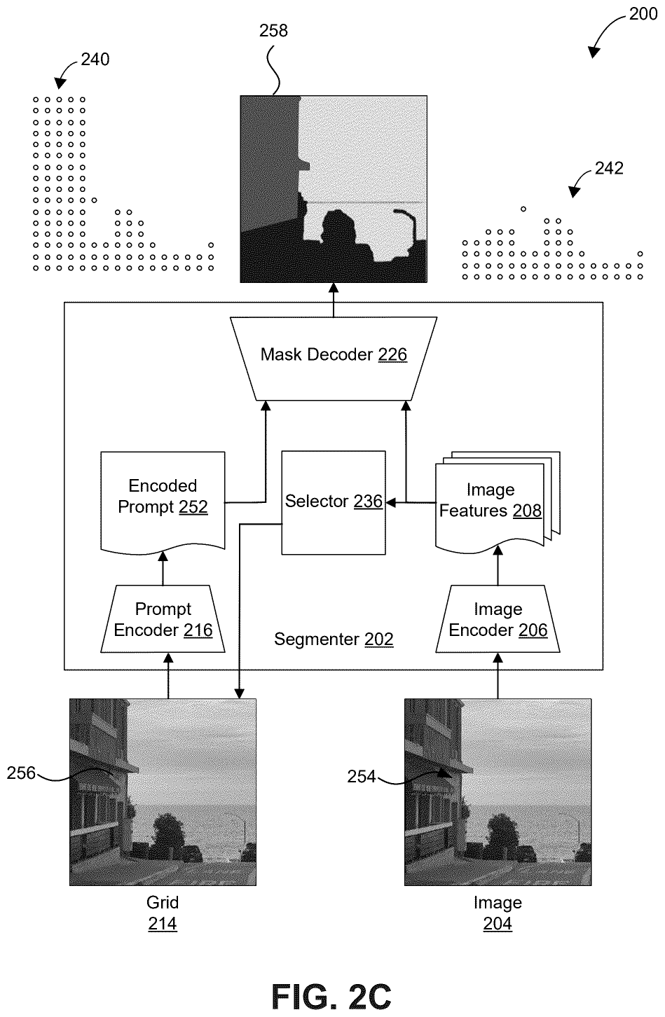

FIG. 2A is a diagram illustrating an example system 200 for segmenting image data, according to various aspects of the present disclosure. For example, a segmenter 202 of system 200 may generate a segmentation map 228 that may segment an image 204, for example, by labeling pixels of image 204 according to semantic segments of image 204.

Segmenter 202 (and/or one or more elements of segmenter 202) may be similar to segmenter 102 of FIG. 1 (and/or corresponding elements of segmenter 102). For example, segmenter 202 may be trained, according to an iterative backpropagation training process to generate segmentation maps based on images. Segmenter 202 may be trained according to an end-to-end training process or elements of segmenter 202 may be trained separately.

Image encoder 206 may be the same as, may be substantially similar to, and/or may perform the same, or substantially the same, operations as image encoder 106 of FIG. 1. Image encoder 206 may generate image features 208 based on image 204. Image features 208 may be a latent feature space representation of image 204.

Prompt encoder 216 may be the same as, may be substantially similar to, and/or may perform the same, or substantially the same, operations as prompt encoder 116 of FIG. 1. Prompt encoder 216 may generate encoded prompts 218 based on grid 214. Encoded prompts 218 may be, or may include, latent-feature representations of points of grid 214.

Mask decoder 226 may be the same as, may be substantially similar to, and/or may perform the same, or substantially the same, operations as mask decoder 126 of FIG. 1. Mask decoder 226 may decode image features 208, using each of encoded prompts 218 as prompts, to generate masks based on image features 208 and on each of encoded prompts 218. Though not illustrated in FIG. 2A, an accumulator may accumulate the masks to generate segmentation map 228.

Additionally, segmenter 202 includes a selector 236. Selector 236 may select points of grid 214 such that not all points of grid 214 are used to generate respective masks. For example, selector 236 may select one point of grid 214 for each feature of image features 208.

By selecting points of grid 214 such that fewer than all points of grid 214 are used, selector 236 may conserve computational resources, for example, by selecting points of grid 214 such that similar masks will not be generated multiple times.

In some aspects, selector 236 may iteratively determine a prompt point (e.g., a point of grid 214). For example, selector 236 may determine the prompt points based on an affinity matrix derived based on image features 208. The affinity matrix may indicate the similarity between image features 208. For example, the affinity matrix may identify groups or clusters of features of image features 208 with high similarity one to another. A point that closely resembles most of the other members within each cluster or group may be identified as a prompt point for the cluster or group. For example, the point that maximizes the mean similarity of the affinity matrix may be selected as a prompt point. Selector 236 may map each prompt point to an image coordinate and determine a point of grid 214 to use as a prompt to generate a mask. System 200 may then use the determined points to generate masks and mask decoder 226 may accumulate the generated masks to generate segmentation map 228.

FIG. 2B is a diagram including example images to illustrate example operations of system 200, according to various aspects of the present disclosure. For example, FIG. 2B may illustrate a first iteration of a process of segmenting image 204. For example, FIG. 2B may illustrate generating a first mask of a segmentation map based on image 204.

Image encoder 206 may encode image 204 to generate image features 208 and selector 236 may determine a first prompt point based on image features 208. For example, selector 236 may generate an affinity matrix based on image features 208. The affinity matrix may indicate a similarity of each of image features 208 to the others of image features 208. Using the affinity matrix, selector 236 may select a first feature of image features 208. For example, selector 236 may select the first feature based on the first feature having the highest mean similarity relative to all the other features of image features 208. Having selected the first feature, selector 236 may map the first feature to a point of grid 214. Prompt encoder 216 may encode the point of grid 214 to generate an encoded prompt 248 and mask decoder 226 may generate a mask 250 based on image features 208 and encoded prompt 248.

For example, image 204 may include a region 244 of pixels representing the same object (e.g., the sky). Selector 236 may determine that a feature related to region 244 is the first feature (e.g., based on the feature related to region 244 being most similar to other features of image features 208). Selector 236 may map the feature to a point 246. Prompt encoder 216 may encode point 246 to generate encoded prompt 248. Mask decoder 226 may decode image features 208, using encoded prompt 248 as a prompt, to generate mask 250. Mask 250 may indicate pixels of image 204 that are semantically similar to point 246. The pixels that are semantically similar to point 246 may relate to region 244 based on the relationship between region 244 and point 246. In this way, system 200 may generate mask 250 to be a mask indicating pixels of image 204 that are all semantically similar to point 246.

In some aspects, selector 236 may update points of grid 214 to prevent the same point of grid 214 from being used as a prompt multiple times. For example, initially, grid 214 may start as grid points 238. After generating mask 250, selector 236 may determine points of grid points 238 that correspond to mask 250 and exclude such points from being selected as a point in future iterations of the segmenting process. For example, selector 236 may update grid 214 to include grid points 240, for example, excluding points of grid points 238 that correspond to mask 250.

FIG. 2C is a diagram including example images to illustrate example operations of system 200, according to various aspects of the present disclosure. For example, FIG. 2C may illustrate a second iteration (e.g., following the iteration described with regard to FIG. 2B) of a process of segmenting image 204. For example, FIG. 2C may illustrate generating a second mask of a segmentation map based on image 204.

For example, after having selected a first feature, determined a first prompt point, and generated a first mask, selector 236 may determine a second prompt point based on image features 208 (e.g., without regenerating image features 208). For instance, selector 236 may select a second feature of image features 208 using the previously-generated affinity matrix. For example, selector 236 may select the second feature based on the second feature being most similar (after the first feature) to all the other features of image features 208. In some aspects, selector 236 may use an updated grid of points (e.g., grid points 240) to select the second feature. Additionally or alternatively, selector 236 may select the second feature based on the second feature being the second-most-similar to other features of image features 208 as indicated by the affinity matrix.

Having selected the second feature, selector 236 may map the second feature to a point of grid 214. Prompt encoder 216 may encode the point of grid 214 to generate an encoded prompt 252 and mask decoder 226 may generate a mask 250 based on image features 208 and encoded prompt 252.

For example, image 204 may include a region 254 of pixels representing the same object (e.g., a building). Selector 236 may determine that a feature related to region 254 is the second feature (e.g., based on the feature related to region 254 being most similar to other features of image features 208, excluding the first feature). Selector 236 may map the second feature to a point 256. Prompt encoder 216 may encode point 256 to generate encoded prompt 252. Mask decoder 226 may decode image features 208, using encoded prompt 252 as a prompt, to generate mask 258. Mask 258 may indicate pixels of image 204 that are semantically similar to point 256. The pixels that are semantically similar to point 256 may relate to region 254 based on the relationship between region 254 and point 256. In this way, system 200 may generate mask 258 to be a mask indicating pixels of image 204 that are all semantically similar to point 256.

In some aspects, after generating mask 258, selector 236 may determine points of grid points 240 that correspond to mask 258 and exclude such points from being selected as a point in future iterations of the segmenting process. For example, selector 236 may update grid 214 to include grid points 242, for example, excluding points of grid points 240 that correspond to mask 258.

The process described with regard to FIG. 2B and FIG. 2C may be repeated any number of times, for example, until each point of grid 214 has been associated with a mask and excluded from updated grid points or until each pixel of image 204 is associated with a mask and image 204 is segmented.

The process described with regard to FIG. 2B and FIG. 2C may repeat fewer times than the process described with regard to FIG. 1. For example, because selector 236 may select a point of grid 214 that does not relate to a generated mask to use at each iteration, selector 236 may not select points that are already related to generated masks. Thus, selector 236 may allow system 200 to not generate substantially the same mask multiple times. Thus, system 200 may conserve computational resources (by not generating substantially the same mask multiple times) as compared with system 100 of FIG. 1.

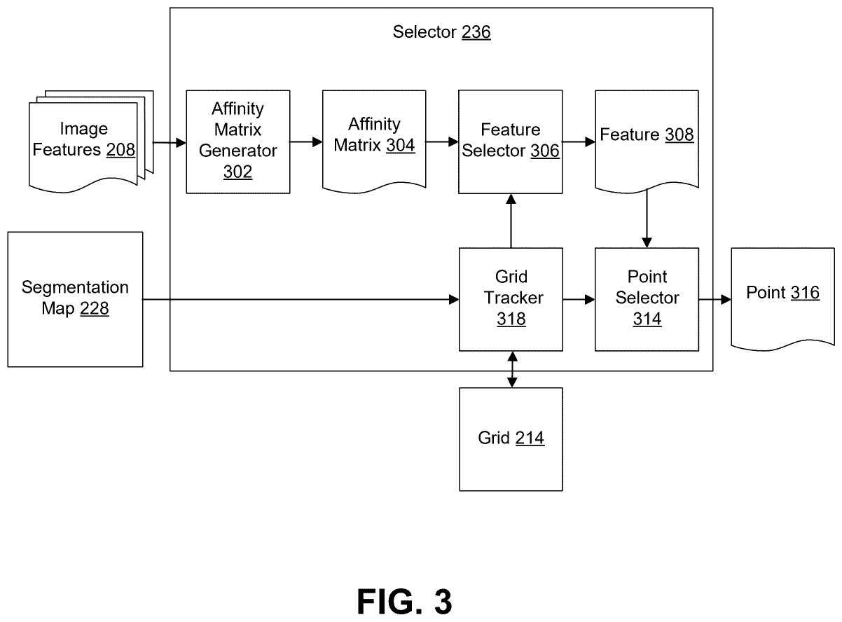

FIG. 3 is a block diagram illustrating an example implementation of selector 236 of FIG. 2A, FIG. 2B, and FIG. 2C, according to various aspects of the present disclosure. For example, selector 236 may generate a point 316 indicative of a point of grid 214 to use as a prompt in an iteration of the process of segmenting image features 208 to generate segmentation map 228.

An affinity matrix generator 302 of selector 236 may generate an affinity matrix 304 based on image features 208. Affinity matrix 304 may be indicative of a similarity of each of image features 208 to each of the others of image features 208. For example, affinity matrix 304 may indicate a similarity of a first given one of image features 208 to all the others of image features 208. Further, affinity matrix 304 may indicate a similarity of a second given one of image features 208 to all the other of image features 208, including the first given one of image features 208.

A feature selector 306 may select one of image features 208 as feature 308 each iteration of the process. In some aspects, feature selector 306 may keep a track of selected ones of image features 208 and at each iteration of the segmenting process select a previously-unselected one of image features 208. In some aspects, feature selector 306 may select each of image features 208 in turn, in no particular order.

In some aspects, feature selector 306 may select feature 308 based on feature 308 being the one of image features 208 that is most similar to all the others of image features 208 that has not previously been selected. The feature with the maximum mean similarity may be the feature that most resembles the other features. Therefore, the feature with the maximum mean similarity may best represent the other features. Using the selected point as a prompt causes segmenter 202 to generate a high quality mask. For example, feature selector 306 may select feature 308 based on feature 308 having a highest mean similarity relative to all the others of image features 208. In some aspects, feature selector 306 may select image features 208 in order of similarity between the selected one of image features 208 and all the other ones of image features 208. For example, feature selector 306 may first select one of image features 208 that is most similar to all the others of image features 208, second feature selector 306 may select one of image features 208 that is second-most similar to all of the others of image features 208.

In some aspects, feature selector 306 may use on an input from grid tracker 318 to determine which of image features 208 have not been selected. For example, grid tracker 318 may track which points of grid 214 relate to masks that have been generated by mask decoder 226. For example, when a mask is generated, the mask may be compared with points of grid 214 and points of grid 214 that relate to the mask may be removed from an updated grid. For example, grid tracker 318 may update grid points 238 to grid points 240 based on the generation of mask 250 and update grid points 240 to grid points 242 based on mask 258. Feature selector 306 may use an updated grid to determine which of image features 208 to select as feature 308, for example, based on which points of grid 214 do not relate to a generated mask.

Point selector 314 may determine point 316 based on feature 308. For example, point selector 314 may map feature 308 to grid 214 (or to an updated version of grid 214 provided by grid tracker 318).

Prompt encoder 216 of FIG. 2A, FIG. 2B, and FIG. 2C may use point 316 as an input and generate one of encoded prompts 218 based on point 316.

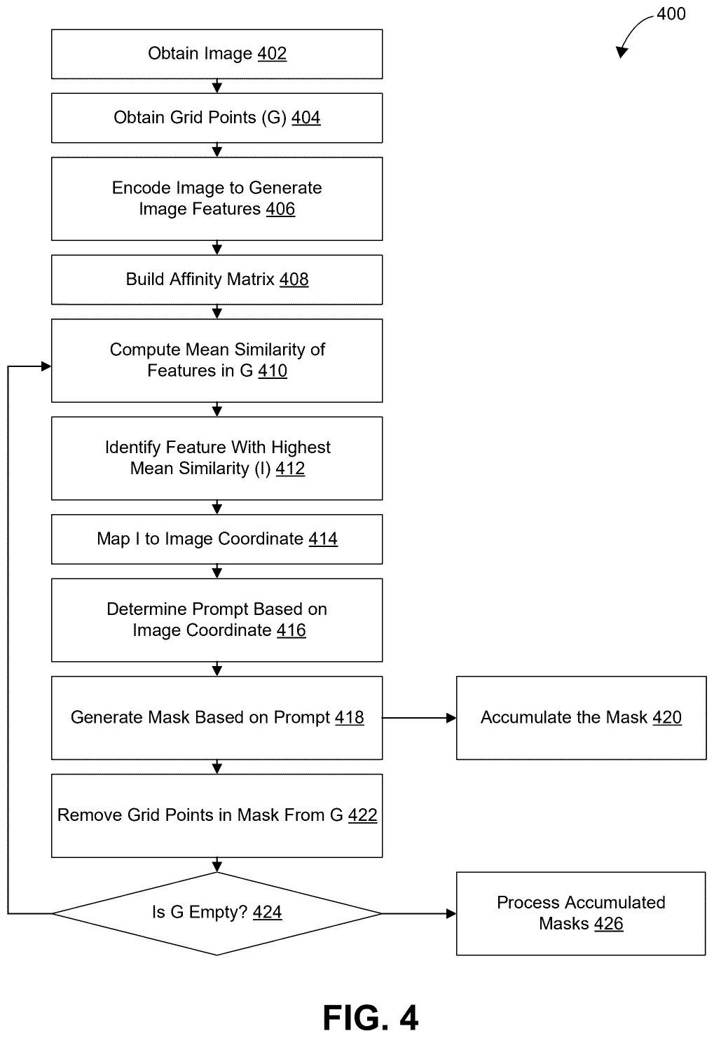

FIG. 4 is a flow diagram illustrating an example process 400 for segmenting image data, in accordance with aspects of the present disclosure. One or more operations of process 400 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, a desktop computing device, a tablet computing device, a server computer, a robotic device, and/or any other computing device with the resource capabilities to perform the process 400. The one or more operations of process 400 may be implemented as software components that are executed and run on one or more processors.

At block 402 a computing device (and/or one or more component thereof) may obtain an image. For example, system 200 of FIG. 2A, FIG. 2B, and FIG. 2C may obtain image 204.

At block 404, the computing device (and/or one or more component thereof) may obtain a grid of points (G). For example, system 200 may obtain grid 214.

At block 406, the computing device (and/or one or more component thereof) may encode the image to generate image features. For example, image encoder 206 of FIG. 2A, FIG. 2B, and FIG. 2C may generate image features 208 based on image 204. In some aspects, image encoder 206 may generate image features 208 based on the dimensions of grid 214 obtained at block 404.

At block 408, the computing device (and/or one or more component thereof) may build an affinity matrix. For example, affinity matrix generator 302 of FIG. 3 may generate affinity matrix 304.

At block 410, the computing device (and/or one or more component thereof) may compute the mean similarity of features in the remaining number of grid points—G. For example, feature selector 306 of FIG. 3 may compute a mean similarity between each of image features 208 and all the others of image features 208.

At block 412, the computing device (and/or one or more component thereof) may identify a feature with the highest mean similarity (I). For example, feature selector 306 may identify feature 308 based on feature 308 having the highest mean similarity to others of image features 208.

At block 414, the computing device (and/or one or more component thereof) may map the feature selected at block 412-I-to image coordinates. For example, point selector 314 of FIG. 3 may map feature 308 to image coordinates.

At block 416, the computing device (and/or one or more component thereof) may determine a prompt based on the image coordinates determined at block 414. For example, point selector 314 may map the image coordinates to a point 316 of grid 214.

At block 418, the computing device (and/or one or more component thereof) may generate a mask based on the prompt determined at block 416. For example, prompt encoder 216 of FIG. 2A, FIG. 2B, and FIG. 2C may encode the point 316 as one of encoded prompts 218. Further, mask decoder 226 of FIG. 2A, FIG. 2B, and FIG. 2C may generate a mask based on the one of encoded prompts 218 and image features 208.

At block 420, the computing device (and/or one or more component thereof) may accumulate the mask generated at block 418. For example, the mask generated by mask decoder 226 may be accumulated (e.g., with other masks from other iterations of process 400). Accumulating the masks may be part of generating a segmentation map.

At block 422, the computing device (and/or one or more component thereof) may remove grid points related to the mask from G. For example, grid tracker 318 of FIG. 3 may remove points from grid 214 that are related to the mask generated at block 418.

At decision block 424, the computing device (and/or one or more component thereof) may determine whether G is empty, for example, if the last point or points have been removed at block 422. If there are points in G, process 400 may return to block 410. If G is empty, process 400 may proceed to block 426.

At block 426, the computing device (and/or one or more component thereof) may process the accumulated masks. For example, at block 426 a mask may be determined for any pixels associated with two or more masks. Additionally or alternatively, a mask may be determined for any pixels that are not associated with a mask.

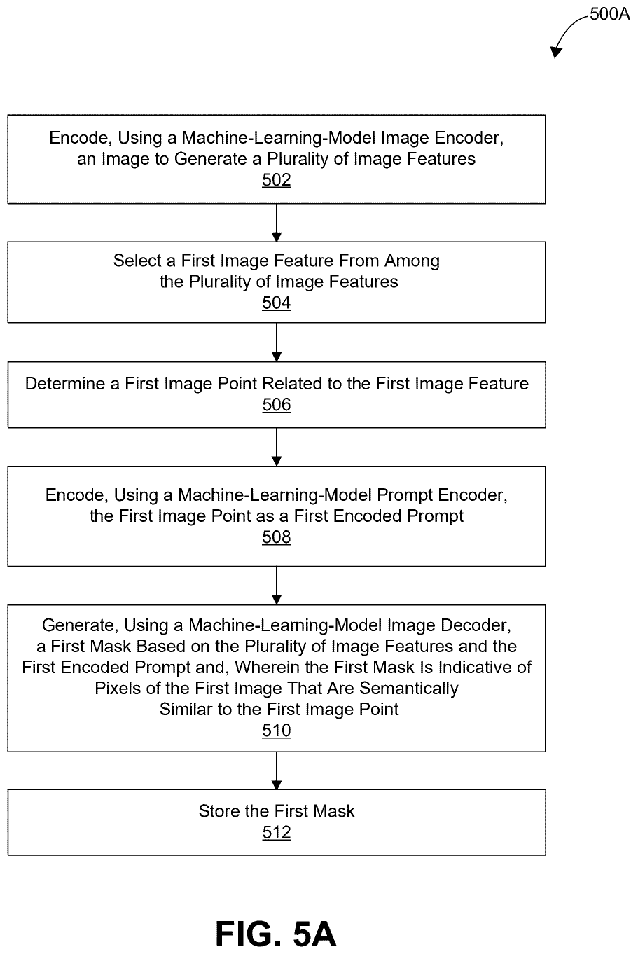

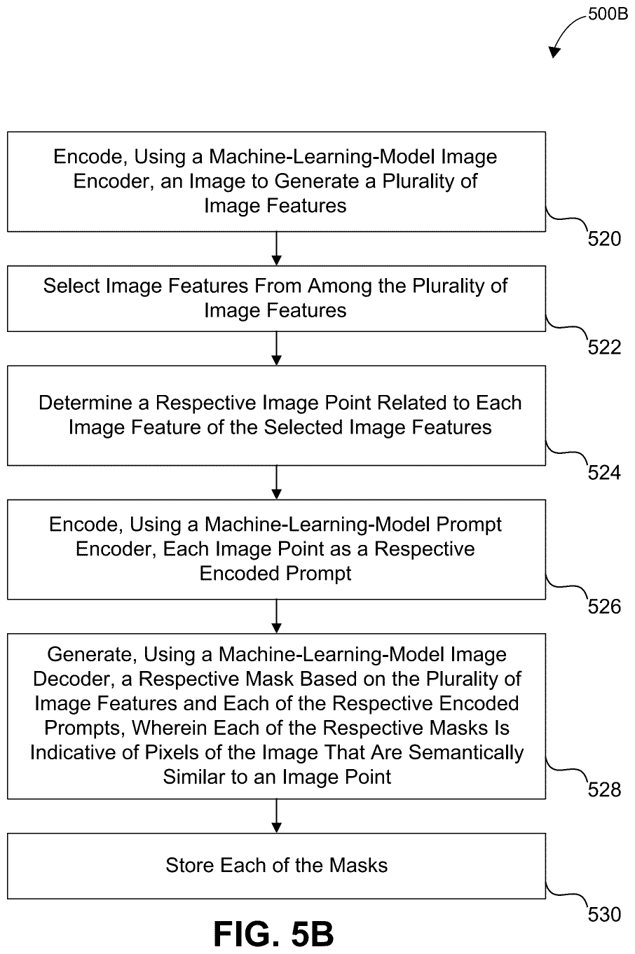

FIG. 5A is a flow diagram illustrating an example process 500A for segmenting image data, in accordance with aspects of the present disclosure. One or more operations of process 500A may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, a desktop computing device, a tablet computing device, a server computer, a robotic device, and/or any other computing device with the resource capabilities to perform the process 500A. The one or more operations of process 500A may be implemented as software components that are executed and run on one or more processors.

At block 502, a computing device (or one or more components thereof) may encode, using a machine-learning-model image encoder, an image to generate a plurality of image features. For example, segmenter 202 of FIG. 2A, FIG. 2B, FIG. 2C, and FIG. 3 may use image encoder 206 to encoder block 402 to generate image features 208.

At block 504, the computing device (or one or more components thereof) may select a first image feature from among the plurality of image features. For example, selector 236 of segmenter 202 may select an image feature from among image features 208.

In some aspects, the computing device (or one or more components thereof) may determine an affinity matrix based on plurality of image features, wherein the first image feature is selected based on the affinity matrix. For example, affinity matrix generator 302 of FIG. 3 of selector 236 may determine affinity matrix 304 based on image features 208. Feature selector 306 may select feature 308 from among image features 208 based on affinity matrix 304.

In some aspects, the affinity matrix may be indicative of similarities between each image feature of the plurality of image features. For example, affinity matrix 304 may be indicative of similarities between each image feature of image features 208 and each of the other image features of image features 208.

In some aspects, the first image feature is selected from among the plurality of image features based on the first image feature having a highest mean similarity of the affinity matrix. For example, feature selector 306 may select feature 308 from among image features 208 based on feature 308 having a highest mean similarity in affinity matrix 304.

At block 506, the computing device (or one or more components thereof) may determine a first image point related to the first image feature. For example, selector 236 may determine an image point (e.g., a coordinate) related to the image features selected at block 504.

In some aspects, to determine the first image point related to the first image feature, the computing device (or one or more components thereof) may map the first image feature to a grid point. For example, selector 236 may map feature 308 to a grid point of grid 214.

At block 508, the computing device (or one or more components thereof) may encode, using a machine-learning-model prompt encoder, the first image point as a first encoded prompt. For example, segmenter 202 may use prompt encoder 216 to encode the image point determined at block 506 as a first encoded prompt (e.g., of encoded prompts 218).

At block 510, the computing device (or one or more components thereof) may generate, using a machine-learning-model image decoder, a first mask based on the plurality of image features and the first encoded prompt, wherein the first mask is indicative of pixels of the image that are semantically similar to the first image point. For example, segmenter 202 may use mask decoder 226 to generate a first mask based on image features 208 and the prompt encoded at block 508.

At block 512, the computing device (or one or more components thereof) may store the first mask. For example, system 200 may store a mask output by mask decoder 226 as a mask that may be used at make up segmentation map 228.

In some aspects, the computing device (or one or more components thereof) may select a second image feature from among the plurality of image features; determine a second image point related to the second image feature; encode, using the machine-learning-model prompt encoder, the second image point as a second encoded prompt; generate, using the machine-learning-model image decoder, a second mask based on the plurality of image features and the second encoded prompt; and store the second mask. For example, selector 236 of segmenter 202 may select a second image feature from among image features 208. Segmenter 202 may use image features 208 without having to encode image 204 as image features 208 again. Selector 236 may select the second image feature from among image features 208 based on the second image feature having a highest mean similarity score (excluding the previously-selected image feature) as indicated by affinity matrix 304. Selector 236 may use affinity matrix 304 without having to determine affinity matrix 304 again. Selector 236 may determine a second image point related to the second image feature. For example, selector 236 may map the second image feature to a grid point of grid 214. Segmenter 202 may use prompt encoder 216 to encode the second image point as a second encoded prompt (e.g., of encoded prompts 218). Segmenter 202 may use mask decoder 226 to generate a second mask based on image features 208 and the second encoded prompt. System 200 may store the second mask as a mask that may be used at make up segmentation map 228.

In some aspects, the computing device (or one or more components thereof) may select image features from among the plurality of image features; determine a respective image point related to each image feature of the selected image features; encode, using the machine-learning-model prompt encoder, each image point as a respective encoded prompt; generate, using the machine-learning-model image decoder, a respective mask based on the plurality of image features and each respective encoded prompt of each image point; and store each respective mask. For example, selector 236 of segmenter 202 may select image features from among image features 208, for example, iteratively. Segmenter 202 may use image features 208 without having to encode image 204 as image features 208 again. Selector 236 may select the image features from among image features 208 by selecting, at each iteration, an image feature having a highest mean similarity score (excluding the image features selected at previous iterations) as indicated by affinity matrix 304. Selector 236 may use affinity matrix 304 without having to determine affinity matrix 304 again. Selector 236 may determine an image point related to each of the image features as they are selected. For example, selector 236 may map the image features to a grid point of grid 214. Segmenter 202 may use prompt encoder 216 to encode the image points as they are selected as encoded prompts (e.g., of encoded prompts 218). Segmenter 202 may use mask decoder 226 to generate masks based on image features 208 and the encoded prompts, as they are encoded. System 200 may store the masks to iteratively build up segmentation map 228.

In some aspects, the computing device (or one or more components thereof) may accumulate each respective mask to generate a segmentation map of the image. For example, as selector 236 iteratively selects image features from among image features 208, and segmenter 202 generates masks based on the selected image features, system 200 may accumulate the masks to generate segmentation map 228.

FIG. 5B is a flow diagram illustrating an example process 500B for segmenting image data, in accordance with aspects of the present disclosure. One or more operations of process 500B may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, a desktop computing device, a tablet computing device, a server computer, a robotic device, and/or any other computing device with the resource capabilities to perform the process 500B. The one or more operations of process 500B may be implemented as software components that are executed and run on one or more processors.

At block 520, a computing device (or one or more components thereof) may encode, using a machine-learning-model image encoder, an image to generate a plurality of image features. For example, segmenter 202 of FIG. 2A, FIG. 2B, FIG. 2C, and FIG. 3 may use image encoder 206 to encoder block 402 to generate image features 208.

At block 522, the computing device (or one or more components thereof) may select image features from among the plurality of image features. For example, selector 236 of segmenter 202 may select an image feature, for example iteratively, from among image features 208.

In some aspects, the computing device (or one or more components thereof) may determine an affinity matrix based on plurality of image features and determine an order in which to select the image features based on the affinity matrix. The image features are selected, at block 522, based on the order. For example, affinity matrix generator 302 of FIG. 3 of selector 236 may determine affinity matrix 304 based on image features 208. Feature selector 306 may select feature 308 from among image features 208 based on affinity matrix 304. In some aspects, the affinity matrix may be indicative of similarities between each image feature of the plurality of image features. For example, affinity matrix 304 may be indicative of similarities between each image feature of image features 208 and each of the other image features of image features 208.

In some aspects, the order may be determined based on mean similarities of the affinity matrix. For example, the order in which the image features is selected, at block 522, may be based on the affinity matrix. For example, the image features may be selected based on an ordering of the mean similarity of the image features. For instance an image feature with the highest mean similarity may be selected first, followed by an image feature with the second-highest mean similarity.

At block 524, the computing device (or one or more components thereof) may determine a respective image point related to each image feature of the selected image features. For example, selector 236 may determine an image point (e.g., a coordinate) related to each respective image feature selected at block 522. The image points may be determined iteratively, for example, as the features are selected iteratively at block 522. In some aspects, to determine the image points, the computing device (or one or more components thereof) may map the image features to grid points. For example, selector 236 may map image features, as they are selected, to respective grid points of grid 214.

At block 526, the computing device (or one or more components thereof) may encode, using a machine-learning-model prompt encoder, each image point as a respective encoded prompt. For example, segmenter 202 may use prompt encoder 216 to encode each image point determined at block 524 as a respective encoded prompt (e.g., of encoded prompts 218).

At block 528, the computing device (or one or more components thereof) may generate, using a machine-learning-model image decoder, a respective mask based on the plurality of image features and each of the respective encoded prompts, wherein each of the respective masks is indicative of pixels of the image that are semantically similar to an image point. For example, segmenter 202 may use mask decoder 226 to generate a mask based on image features 208 and each of the prompt encoded at block 526.

At block 530, the computing device (or one or more components thereof) may store each of the masks. For example, system 200 may store each mask output by mask decoder 226 at block 528 as a respective mask of segmentation map 228.

In some aspects, the computing device (or one or more components thereof) may accumulate each respective mask generated at block 530 to generate a segmentation map of the image. For example, as selector 236 iteratively selects image features from among image features 208 (at block 522), and segmenter 202 generates masks based on the selected image features, system 200 may accumulate the masks to generate segmentation map 228.

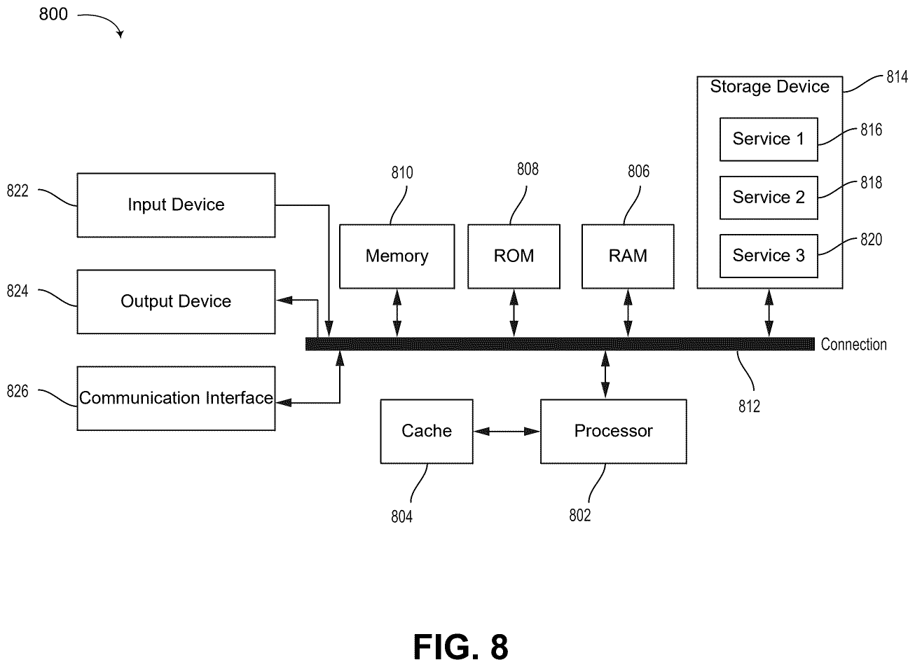

In some examples, as noted previously, the methods described herein (e.g., process 400 of FIG. 4, process 500A of FIG. 5A, process 500B of FIG. 5B, and/or other methods described herein) can be performed, in whole or in part, by a computing device or apparatus. In one example, one or more of the methods can be performed by system 200 of FIG. 2A, FIG. 2B, and FIG. 2C, segmenter 202 of FIG. 2A, FIG. 2B, and FIG. 2C, selector 236 of FIG. 2A, FIG. 2B, FIG. 2C, and FIG. 3, or by another system or device. In another example, one or more of the methods (e.g., process 400, process 500A, process 500B and/or other methods described herein) can be performed, in whole or in part, by the computing-device architecture 800 shown in FIG. 8. For instance, a computing device with the computing-device architecture 800 shown in FIG. 8 can include, or be included in, the components of the system 200, selector 236, and can implement the operations of process 400, process 500A, process 500B, and/or other process described herein. In some cases, the computing device or apparatus can include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device can include a display, a network interface configured to communicate and/or receive the data, any combination thereof, and/or other component(s). The network interface can be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

Process 400, process 500A, process 500B, and/or other process described herein are illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, process 400, process 500A, process 500B, and/or other process described herein can be performed under the control of one or more computer systems configured with executable instructions and can be implemented as code (e.g., executable instructions, one or more computer programs, or one or more applications) executing collectively on one or more processors, by hardware, or combinations thereof. As noted above, the code can be stored on a computer-readable or machine-readable storage medium, for example, in the form of a computer program comprising a plurality of instructions executable by one or more processors. The computer-readable or machine-readable storage medium can be non-transitory.

As noted above, various aspects of the present disclosure can use machine-learning models or systems.

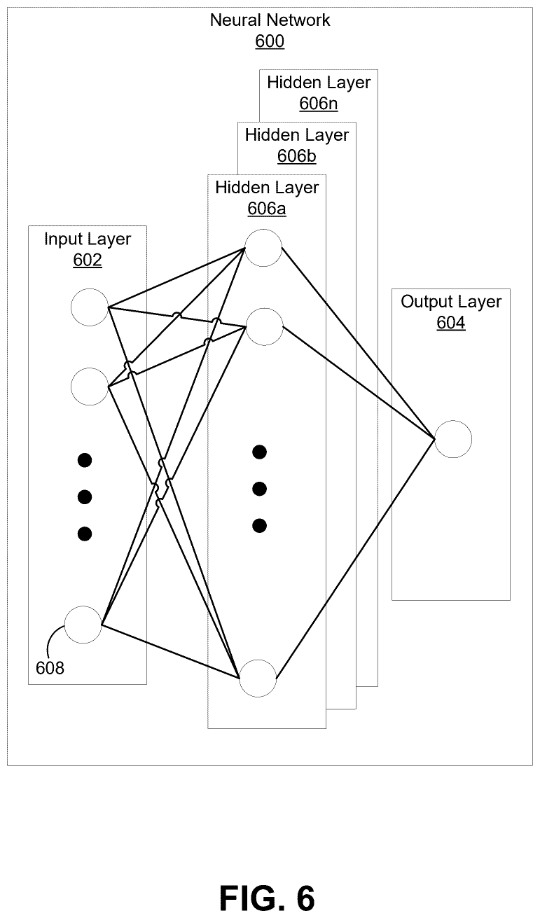

FIG. 6 is an illustrative example of a neural network 600 (e.g., a deep-learning neural network) that can be used to implement machine-learning based feature segmentation, implicit-neural-representation generation, rendering, classification, object detection, image recognition (e.g., face recognition, object recognition, scene recognition, etc.), feature extraction, authentication, gaze detection, gaze prediction, and/or automation. For example, neural network 600 may be an example of, or can implement, image encoder 206 of FIG. 2A, FIG. 2B, and FIG. 2C, prompt encoder 216 of FIG. 2A, FIG. 2B, and FIG. 2C, and/or mask decoder 226 FIG. 2A, FIG. 2B, and FIG. 2C.

An input layer 602 includes input data. In one illustrative example, input layer 602 can include data representing image 204 FIG. 2A, FIG. 2B, and FIG. 2C, a point of grid 214 FIG. 2A, FIG. 2B, and FIG. 2C, and/or one of encoded prompts 218 and image features 208 of FIG. 2A, FIG. 2B, and FIG. 2C. Neural network 600 includes multiple hidden layers, for example, hidden layers 606a, 606b, through 606n. The hidden layers 606a, 606b, through hidden layer 606n include “n” number of hidden layers, where “n” is an integer greater than or equal to one. The number of hidden layers can be made to include as many layers as needed for the given application. Neural network 600 further includes an output layer 604 that provides an output resulting from the processing performed by the hidden layers 606a, 606b, through 606n. In one illustrative example, output layer 604 can provide image features 208 FIG. 2A, FIG. 2B, and FIG. 2C, prompt encoder 216 FIG. 2A, FIG. 2B, and FIG. 2C, and/or masks of segmentation map 228 FIG. 2A such as mask 250 of FIG. 2B and mask 258 of FIG. 2C.

Neural network 600 may be, or may include, a multi-layer neural network of interconnected nodes. Each node can represent a piece of information. Information associated with the nodes is shared among the different layers and each layer retains information as information is processed. In some cases, neural network 600 can include a feed-forward network, in which case there are no feedback connections where outputs of the network are fed back into itself. In some cases, neural network 600 can include a recurrent neural network, which can have loops that allow information to be carried across nodes while reading in input.

Information can be exchanged between nodes through node-to-node interconnections between the various layers. Nodes of input layer 602 can activate a set of nodes in the first hidden layer 606a. For example, as shown, each of the input nodes of input layer 602 is connected to each of the nodes of the first hidden layer 606a. The nodes of first hidden layer 606a can transform the information of each input node by applying activation functions to the input node information. The information derived from the transformation can then be passed to and can activate the nodes of the next hidden layer 606b, which can perform their own designated functions. Example functions include convolutional, up-sampling, data transformation, and/or any other suitable functions. The output of the hidden layer 606b can then activate nodes of the next hidden layer, and so on. The output of the last hidden layer 606n can activate one or more nodes of the output layer 604, at which an output is provided. In some cases, while nodes (e.g., node 608) in neural network 600 are shown as having multiple output lines, a node has a single output and all lines shown as being output from a node represent the same output value.

In some cases, each node or interconnection between nodes can have a weight that is a set of parameters derived from the training of neural network 600. Once neural network 600 is trained, it can be referred to as a trained neural network, which can be used to perform one or more operations. For example, an interconnection between nodes can represent a piece of information learned about the interconnected nodes. The interconnection can have a tunable numeric weight that can be tuned (e.g., based on a training dataset), allowing neural network 600 to be adaptive to inputs and able to learn as more and more data is processed.

Neural network 600 may be pre-trained to process the features from the data in the input layer 602 using the different hidden layers 606a, 606b, through 606n in order to provide the output through the output layer 604. In an example in which neural network 600 is used to identify features in images, neural network 600 can be trained using training data that includes both images and labels, as described above. For instance, training images can be input into the network, with each training image having a label indicating the features in the images (for the feature-segmentation machine-learning system) or a label indicating classes of an activity in each image. In one example using object classification for illustrative purposes, a training image can include an image of a number 2, in which case the label for the image can be [00 10000000].

In some cases, neural network 600 can adjust the weights of the nodes using a training process called backpropagation. As noted above, a backpropagation process can include a forward pass, a loss function, a backward pass, and a weight update. The forward pass, loss function, backward pass, and parameter update are performed for one training iteration. The process can be repeated for a certain number of iterations for each set of training images until neural network 600 is trained well enough so that the weights of the layers are accurately tuned.

For the example of identifying objects in images, the forward pass can include passing a training image through neural network 600. The weights are initially randomized before neural network 600 is trained. As an illustrative example, an image can include an array of numbers representing the pixels of the image. Each number in the array can include a value from 0 to 255 describing the pixel intensity at that position in the array. In one example, the array can include a 28×28×3 array of numbers with 28 rows and 28 columns of pixels and 3 color components (such as red, green, and blue, or luma and two chroma components, or the like).

As noted above, for a first training iteration for neural network 600, the output will likely include values that do not give preference to any particular class due to the weights being randomly selected at initialization. For example, if the output is a vector with probabilities that the object includes different classes, the probability value for each of the different classes can be equal or at least very similar (e.g., for ten possible classes, each class can have a probability value of 0.1). With the initial weights, neural network 600 is unable to determine low-level features and thus cannot make an accurate determination of what the classification of the object might be. A loss function can be used to analyze error in the output. Any suitable loss function definition can be used, such as a cross-entropy loss. Another example of a loss function includes the mean squared error (MSE), defined as

$${E}_{total} = Σ \frac{1}{2} {( target - output )}^{2} .$$

The loss can be set to be equal to the value of Eₜₒₜₐₗ. The loss (or error) will be high for the first training images since the actual values will be much different than the predicted output. The goal of training is to minimize the amount of loss so that the predicted output is the same as the training label. Neural network 600 can perform a backward pass by determining which inputs (weights) most contributed to the loss of the network and can adjust the weights so that the loss decreases and is eventually minimized. A derivative of the loss with respect to the weights (denoted as dL|dW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as

$$w = {w}_{t} - η \frac{d L}{dW} ,$$

where w denotes the initial weight, wᵢ denotes the initial weight, and η denotes a learning rate. The learning rate can be set to any suitable value, with a high learning rate including larger weight updates and a lower value indicating smaller weight updates.

Neural network 600 can include any suitable deep network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. Neural network 600 can include any other deep network other than a CNN, such as an autoencoder, a deep belief nets (DBNs), a Recurrent Neural Networks (RNNs), among others.

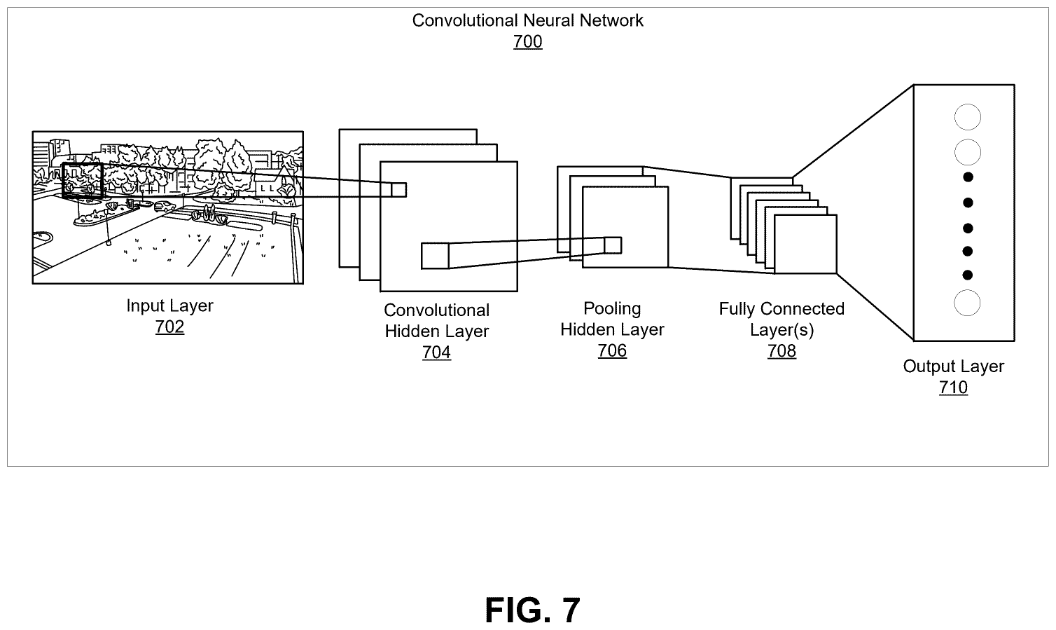

FIG. 7 is an illustrative example of a convolutional neural network (CNN) 700. The input layer 702 of the CNN 700 includes data representing an image or frame. For example, the data can include an array of numbers representing the pixels of the image, with each number in the array including a value from 0 to 255 describing the pixel intensity at that position in the array. Using the previous example from above, the array can include a 28×28×3 array of numbers with 28 rows and 28 columns of pixels and 3 color components (e.g., red, green, and blue, or luma and two chroma components, or the like). The image can be passed through a convolutional hidden layer 704, an optional non-linear activation layer, a pooling hidden layer 706, and fully connected layer 708 (which fully connected layer 708 can be hidden) to get an output at the output layer 710. While only one of each hidden layer is shown in FIG. 7, one of ordinary skill will appreciate that multiple convolutional hidden layers, non-linear layers, pooling hidden layers, and/or fully connected layers can be included in the CNN 700. As previously described, the output can indicate a single class of an object or can include a probability of classes that best describe the object in the image.

The first layer of the CNN 700 can be the convolutional hidden layer 704. The convolutional hidden layer 704 can analyze image data of the input layer 702. Each node of the convolutional hidden layer 704 is connected to a region of nodes (pixels) of the input image called a receptive field. The convolutional hidden layer 704 can be considered as one or more filters (each filter corresponding to a different activation or feature map), with each convolutional iteration of a filter being a node or neuron of the convolutional hidden layer 704. For example, the region of the input image that a filter covers at each convolutional iteration would be the receptive field for the filter. In one illustrative example, if the input image includes a 28×28 array, and each filter (and corresponding receptive field) is a 5×5 array, then there will be 24×24 nodes in the convolutional hidden layer 704. Each connection between a node and a receptive field for that node learns a weight and, in some cases, an overall bias such that each node learns to analyze its particular local receptive field in the input image. Each node of the convolutional hidden layer 704 will have the same weights and bias (called a shared weight and a shared bias). For example, the filter has an array of weights (numbers) and the same depth as the input. A filter will have a depth of 3 for an image frame example (according to three color components of the input image). An illustrative example size of the filter array is 5×5×3, corresponding to a size of the receptive field of a node.

The convolutional nature of the convolutional hidden layer 704 is due to each node of the convolutional layer being applied to its corresponding receptive field. For example, a filter of the convolutional hidden layer 704 can begin in the top-left corner of the input image array and can convolve around the input image. As noted above, each convolutional iteration of the filter can be considered a node or neuron of the convolutional hidden layer 704. At each convolutional iteration, the values of the filter are multiplied with a corresponding number of the original pixel values of the image (e.g., the 5×5 filter array is multiplied by a 5×5 array of input pixel values at the top-left corner of the input image array). The multiplications from each convolutional iteration can be summed together to obtain a total sum for that iteration or node. The process is next continued at a next location in the input image according to the receptive field of a next node in the convolutional hidden layer 704. For example, a filter can be moved by a step amount (referred to as a stride) to the next receptive field. The stride can be set to 1 or any other suitable amount. For example, if the stride is set to 1, the filter will be moved to the right by 1 pixel at each convolutional iteration. Processing the filter at each unique location of the input volume produces a number representing the filter results for that location, resulting in a total sum value being determined for each node of the convolutional hidden layer 704.

The mapping from the input layer to the convolutional hidden layer 704 is referred to as an activation map (or feature map). The activation map includes a value for each node representing the filter results at each location of the input volume. The activation map can include an array that includes the various total sum values resulting from each iteration of the filter on the input volume. For example, the activation map will include a 24×24 array if a 5×5 filter is applied to each pixel (a stride of 1) of a 28×28 input image. The convolutional hidden layer 704 can include several activation maps in order to identify multiple features in an image. The example shown in FIG. 7 includes three activation maps. Using three activation maps, the convolutional hidden layer 704 can detect three different kinds of features, with each feature being detectable across the entire image.

In some examples, a non-linear hidden layer can be applied after the convolutional hidden layer 704. The non-linear layer can be used to introduce non-linearity to a system that has been computing linear operations. One illustrative example of a non-linear layer is a rectified linear unit (ReLU) layer. A ReLU layer can apply the function f(x)=max(0, x) to all of the values in the input volume, which changes all the negative activations to 0. The ReLU can thus increase the non-linear properties of the CNN 700 without affecting the receptive fields of the convolutional hidden layer 704.

The pooling hidden layer 706 can be applied after the convolutional hidden layer 704 (and after the non-linear hidden layer when used). The pooling hidden layer 706 is used to simplify the information in the output from the convolutional hidden layer 704. For example, the pooling hidden layer 706 can take each activation map output from the convolutional hidden layer 704 and generates a condensed activation map (or feature map) using a pooling function. Max-pooling is one example of a function performed by a pooling hidden layer. Other forms of pooling functions be used by the pooling hidden layer 706, such as average pooling, L2-norm pooling, or other suitable pooling functions. A pooling function (e.g., a max-pooling filter, an L2-norm filter, or other suitable pooling filter) is applied to each activation map included in the convolutional hidden layer 704. In the example shown in FIG. 7, three pooling filters are used for the three activation maps in the convolutional hidden layer 704.

In some examples, max-pooling can be used by applying a max-pooling filter (e.g., having a size of 2×2) with a stride (e.g., equal to a dimension of the filter, such as a stride of 2) to an activation map output from the convolutional hidden layer 704. The output from a max-pooling filter includes the maximum number in every sub-region that the filter convolves around. Using a 2×2 filter as an example, each unit in the pooling layer can summarize a region of 2×2 nodes in the previous layer (with each node being a value in the activation map). For example, four values (nodes) in an activation map will be analyzed by a 2×2 max-pooling filter at each iteration of the filter, with the maximum value from the four values being output as the “max” value. If such a max-pooling filter is applied to an activation filter from the convolutional hidden layer 704 having a dimension of 24×24 nodes, the output from the pooling hidden layer 706 will be an array of 12×12 nodes.

In some examples, an L2-norm pooling filter could also be used. The L2-norm pooling filter includes computing the square root of the sum of the squares of the values in the 2×2 region (or other suitable region) of an activation map (instead of computing the maximum values as is done in max-pooling) and using the computed values as an output.

The pooling function (e.g., max-pooling, L2-norm pooling, or other pooling function) determines whether a given feature is found anywhere in a region of the image and discards the exact positional information. This can be done without affecting results of the feature detection because, once a feature has been found, the exact location of the feature is not as important as its approximate location relative to other features. Max-pooling (as well as other pooling methods) offer the benefit that there are many fewer pooled features, thus reducing the number of parameters needed in later layers of the CNN 700.

The final layer of connections in the network is a fully-connected layer that connects every node from the pooling hidden layer 706 to every one of the output nodes in the output layer 710. Using the example above, the input layer includes 28×28 nodes encoding the pixel intensities of the input image, the convolutional hidden layer 704 includes 3×24×24 hidden feature nodes based on application of a 5×5 local receptive field (for the filters) to three activation maps, and the pooling hidden layer 706 includes a layer of 3×12×12 hidden feature nodes based on application of max-pooling filter to 2×2 regions across each of the three feature maps. Extending this example, the output layer 710 can include ten output nodes. In such an example, every node of the 3×12×12 pooling hidden layer 706 is connected to every node of the output layer 710.

The fully connected layer 708 can obtain the output of the previous pooling hidden layer 706 (which should represent the activation maps of high-level features) and determines the features that most correlate to a particular class. For example, the fully connected layer 708 can determine the high-level features that most strongly correlate to a particular class and can include weights (nodes) for the high-level features. A product can be computed between the weights of the fully connected layer 708 and the pooling hidden layer 706 to obtain probabilities for the different classes. For example, if the CNN 700 is being used to predict that an object in an image is a person, high values will be present in the activation maps that represent high-level features of people (e.g., two legs are present, a face is present at the top of the object, two eyes are present at the top left and top right of the face, a nose is present in the middle of the face, a mouth is present at the bottom of the face, and/or other features common for a person).

In some examples, the output from the output layer 710 can include an M-dimensional vector (in the prior example, M=10). M indicates the number of classes that the CNN 700 has to choose from when classifying the object in the image. Other example outputs can also be provided. Each number in the M-dimensional vector can represent the probability the object is of a certain class. In one illustrative example, if a 10-dimensional output vector represents ten different classes of objects is [00 0.05 0.800.15 000 0], the vector indicates that there is a 5% probability that the image is the third class of object (e.g., a dog), an 80% probability that the image is the fourth class of object (e.g., a human), and a 15% probability that the image is the sixth class of object (e.g., a kangaroo). The probability for a class can be considered a confidence level that the object is part of that class.

FIG. 8 illustrates an example computing-device architecture 800 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. For example, the computing-device architecture 800 may include, implement, or be included in any or all of system 200 of FIG. 2A, FIG. 2B, and FIG. 2C, segmenter 202 of FIG. 2A, FIG. 2B, and FIG. 2C, selector 236 of FIG. 2A, FIG. 2B, FIG. 2C, and FIG. 3, and/or other devices, modules, or systems described herein. Additionally or alternatively, computing-device architecture 800 may be configured to perform process 400 of FIG. 4, process 500A of FIG. 5A, process 500B of FIG. 5B, and/or other process described herein.

The components of computing-device architecture 800 are shown in electrical communication with each other using connection 812, such as a bus. The example computing-device architecture 800 includes a processing unit (CPU or processor) 802 and computing device connection 812 that couples various computing device components including computing device memory 810, such as read only memory (ROM) 808 and random-access memory (RAM) 806, to processor 802.

Computing-device architecture 800 can include a cache of high-speed memory connected directly with, in close proximity to, or integrated as part of processor 802. Computing-device architecture 800 can copy data from memory 810 and/or the storage device 814 to cache 804 for quick access by processor 802. In this way, the cache can provide a performance boost that avoids processor 802 delays while waiting for data. These and other modules can control or be configured to control processor 802 to perform various actions. Other computing device memory 810 may be available for use as well. Memory 810 can include multiple different types of memory with different performance characteristics. Processor 802 can include any general-purpose processor and a hardware or software service, such as service 1 816, service 2 818, and service 3 820 stored in storage device 814, configured to control processor 802 as well as a special-purpose processor where software instructions are incorporated into the processor design. Processor 802 may be a self-contained system, containing multiple cores or processors, a bus, memory controller, cache, etc. A multi-core processor may be symmetric or asymmetric.

To enable user interaction with the computing-device architecture 800, input device 822 can represent any number of input mechanisms, such as a microphone for speech, a touch-sensitive screen for gesture or graphical input, keyboard, mouse, motion input, speech and so forth. Output device 824 can also be one or more of a number of output mechanisms known to those of skill in the art, such as a display, projector, television, speaker device, etc. In some instances, multimodal computing devices can enable a user to provide multiple types of input to communicate with computing-device architecture 800. Communication interface 826 can generally govern and manage the user input and computing device output. There is no restriction on operating on any particular hardware arrangement and therefore the basic features here may easily be substituted for improved hardware or firmware arrangements as they are developed.

Storage device 814 is a non-volatile memory and can be a hard disk or other types of computer readable media which can store data that are accessible by a computer, such as magnetic cassettes, flash memory cards, solid state memory devices, digital versatile disks, cartridges, random-access memories (RAMs) 806, read only memory (ROM) 808, and hybrids thereof. Storage device 814 can include services 816, 818, and 820 for controlling processor 802. Other hardware or software modules are contemplated. Storage device 814 can be connected to the computing device connection 812. In one aspect, a hardware module that performs a particular function can include the software component stored in a computer-readable medium in connection with the necessary hardware components, such as processor 802, connection 812, output device 824, and so forth, to carry out the function.

The term “substantially,” in reference to a given parameter, property, or condition, may refer to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific aspects. For example, a system may be implemented on one or more printed circuit boards or other substrates and may have movable or static components. While the below description and examples use the term “system” to describe various aspects of this disclosure, the term “system” is not limited to a specific configuration, type, or number of objects.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, magnetic or optical disks, USB devices provided with non-volatile memory, networked storage devices, any suitable combination thereof, among others. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general-purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods described above. The computer-readable data storage medium may form part of a computer program product, which may include packaging materials. The computer-readable medium may include memory or data storage media, such as random-access memory (RAM) such as synchronous dynamic random-access memory (SDRAM), read-only memory (ROM), non-volatile random-access memory (NVRAM), electrically erasable programmable read-only memory (EEPROM), flash memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general-purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, such as, a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:

Aspect 1. An apparatus for segmenting images, the apparatus comprising: at least one memory; and at least one processor coupled to the at least one memory and configured to: encode, using a machine-learning-model image encoder, an image to generate a plurality of image features; select a first image feature from among the plurality of image features; determine a first image point related to the first image feature; encode, using a machine-learning-model prompt encoder, the first image point as a first encoded prompt; generate, using a machine-learning-model image decoder, a first mask based on the plurality of image features and the first encoded prompt, wherein the first mask is indicative of pixels of the image that are semantically similar to the first image point; and store the first mask.

Aspect 2. The apparatus of aspect 1, wherein the at least one processor is configured to determine an affinity matrix based on plurality of image features, wherein the first image feature is selected based on the affinity matrix.

Aspect 3. The apparatus of aspect 2, wherein the affinity matrix is indicative of similarities between each image feature of the plurality of image features.

Aspect 4. The apparatus of any one of aspects 2 or 3, wherein the first image feature is selected from among the plurality of image features based on the first image feature having a highest mean similarity of the affinity matrix.

Aspect 5. The apparatus of any one of aspects 1 to 4, wherein, to determine the first image point related to the first image feature, the at least one processor is configured to map the first image feature to a grid point.

Aspect 6. The apparatus of any one of aspects 1 to 5, wherein the at least one processor is configured to: select a second image feature from among the plurality of image features; determine a second image point related to the second image feature; encode, using the machine-learning-model prompt encoder, the second image point as a second encoded prompt; generate, using the machine-learning-model image decoder, a second mask based on the plurality of image features and the second encoded prompt; and store the second mask.

Aspect 7. The apparatus of any one of aspects 1 to 6, wherein the at least one processor is configured to: select image features from among the plurality of image features; determine a respective image point related to each image feature of the selected image features; encode, using the machine-learning-model prompt encoder, each image point as a respective encoded prompt; generate, using the machine-learning-model image decoder, a respective mask based on the plurality of image features and each respective encoded prompt of each image point; and store each respective mask.

Aspect 8. The apparatus of aspect 7, wherein the at least one processor is configured to accumulate each respective mask to generate a segmentation map of the image.

Aspect 9. An apparatus for segmenting images, the apparatus comprising: at least one memory; and at least one processor coupled to the at least one memory and configured to: encode, using a machine-learning-model image encoder, an image to generate a plurality of image features; select image features from among the plurality of image features; determine a respective image point related to each image feature of the selected image features; encode, using a machine-learning-model prompt encoder, each image point as a respective encoded prompt; generate, using a machine-learning-model image decoder, a respective mask based on the plurality of image features and each of the respective encoded prompts, wherein each of the respective masks is indicative of pixels of the image that are semantically similar to an image point; and store each of the masks.

Aspect 10. The apparatus of aspect 9, wherein the at least one processor is configured to: determine an affinity matrix based on plurality of image features; and determine an order in which to select the image features based on the affinity matrix; wherein the image features are selected based on the order.

Aspect 11. The apparatus of aspect 10, wherein the order is determined based on mean similarities of the affinity matrix.

Aspect 12. The apparatus of any one of aspects 9 to 11, wherein the at least one processor is configured to accumulate each of the masks to generate a segmentation map of the image.

Aspect 13. The apparatus of any one of aspects 9 to 12, wherein, to determine respective image points related to image features, the at least one processor is configured to map the image features to respective grid points.

Aspect 14. A method for segmenting images, the method comprising: encoding, using a machine-learning-model image encoder, an image to generate a plurality of image features; selecting a first image feature from among the plurality of image features; determining a first image point related to the first image feature; encoding, using a machine-learning-model prompt encoder, the first image point as a first encoded prompt; generating, using a machine-learning-model image decoder, a first mask based on the plurality of image features and the first encoded prompt, wherein the first mask is indicative of pixels of the image that are semantically similar to the first image point; and storing the first mask.

Aspect 15. The method of aspect 14, further comprising determining an affinity matrix based on plurality of image features, wherein the first image feature is selected based on the affinity matrix.

Aspect 16. The method of aspect 15, wherein the affinity matrix is indicative of similarities between each image feature of the plurality of image features.

Aspect 17. The method of any one of aspects 15 or 16, wherein the first image feature is selected from among the plurality of image features based on the first image feature having a highest mean similarity of the affinity matrix.

Aspect 18. The method of any one of aspects 14 to 17, wherein determining the first image point related to the first image feature comprises mapping the first image feature to a grid point.

Aspect 19. The method of any one of aspects 14 to 18, further comprising: selecting a second image feature from among the plurality of image features; determining a second image point related to the second image feature; encoding, using the machine-learning-model prompt encoder, the second image point as a second encoded prompt; generating, using the machine-learning-model image decoder, a second mask based on the plurality of image features and the second encoded prompt; and storing the second mask.

Aspect 20. The method of any one of aspects 14 to 19, further comprising: selecting image features from among the plurality of image features; determining a respective image point related to each image feature of the selected image features; encoding, using the machine-learning-model prompt encoder, each image point as a respective encoded prompt; generating, using the machine-learning-model image decoder, a respective mask based on the plurality of image features and each respective encoded prompt of each image point; and storing each respective mask.

Aspect 21. The method of aspect 20, further comprising accumulating each respective mask to generate a segmentation map of the image.

Aspect 22. A method for segmenting images, the method comprising: encoding, using a machine-learning-model image encoder, an image to generate a plurality of image features; selecting image features from among the plurality of image features; determining a respective image point related to each image feature of the selected image features; encoding, using a machine-learning-model prompt encoder, each image point as a respective encoded prompt; generating, using a machine-learning-model image decoder, a respective mask based on the plurality of image features and each of the respective encoded prompts, wherein each of the respective masks is indicative of pixels of the image that are semantically similar to an image point; and storing each of the masks.

Aspect 23. The method of aspect 22, further comprising: determining an affinity matrix based on plurality of image features; and determining an order in which to select the image features based on the affinity matrix; wherein the image features are selected based on the order.

Aspect 24. The method of aspect 23, wherein the order is determined based on mean similarities of the affinity matrix.

Aspect 25. The method of any one of aspects 22 to 24, further comprising accumulating each of the masks to generate a segmentation map of the image.

Aspect 26. The method of any one of aspects 22 to 24, wherein determining respective image points related to image features comprises mapping the image features to respective grid points.

Aspect 27. A non-transitory computer-readable storage medium having stored thereon instructions that, when executed by at least one processor, cause the at least one processor to perform operations according to any of aspects 14 to 26.

Aspect 28. An apparatus for providing virtual content for display, the apparatus comprising one or more means for perform operations according to any of aspects 14 to 26.

What is claimed is:

1. An apparatus for segmenting images, the apparatus comprising:
at least one memory; and
at least one processor coupled to the at least one memory and configured to:
encode, using a machine-learning-model image encoder, an image to generate a plurality of image features;
select a first image feature from among the plurality of image features;
determine a first image point related to the first image feature;
encode, using a machine-learning-model prompt encoder, the first image point as a first encoded prompt;
generate, using a machine-learning-model image decoder, a first mask based on the plurality of image features and the first encoded prompt, wherein the first mask is indicative of pixels of the image that are semantically similar to the first image point; and
store the first mask.

2. The apparatus of claim 1, wherein the at least one processor is configured to determine an affinity matrix based on plurality of image features, wherein the first image feature is selected based on the affinity matrix.

3. The apparatus of claim 2, wherein the affinity matrix is indicative of similarities between each image feature of the plurality of image features.

4. The apparatus of claim 2, wherein the first image feature is selected from among the plurality of image features based on the first image feature having a highest mean similarity of the affinity matrix.

5. The apparatus of claim 1, wherein, to determine the first image point related to the first image feature, the at least one processor is configured to map the first image feature to a grid point.

6. The apparatus of claim 1, wherein the at least one processor is configured to:
select a second image feature from among the plurality of image features;
determine a second image point related to the second image feature;
encode, using the machine-learning-model prompt encoder, the second image point as a second encoded prompt;
generate, using the machine-learning-model image decoder, a second mask based on the plurality of image features and the second encoded prompt; and
store the second mask.

7. The apparatus of claim 1, wherein the at least one processor is configured to:
select image features from among the plurality of image features;
determine a respective image point related to each image feature of the selected image features;
encode, using the machine-learning-model prompt encoder, each image point as a respective encoded prompt;
generate, using the machine-learning-model image decoder, a respective mask based on the plurality of image features and each respective encoded prompt of each image point; and
store each respective mask.

8. The apparatus of claim 7, wherein the at least one processor is configured to accumulate each respective mask to generate a segmentation map of the image.

9. An apparatus for segmenting images, the apparatus comprising:
at least one memory; and
at least one processor coupled to the at least one memory and configured to:
encode, using a machine-learning-model image encoder, an image to generate a plurality of image features;
select image features from among the plurality of image features;
determine a respective image point related to each image feature of the selected image features;
encode, using a machine-learning-model prompt encoder, each image point as a respective encoded prompt;
generate, using a machine-learning-model image decoder, a respective mask based on the plurality of image features and each of the respective encoded prompts, wherein each of the respective masks is indicative of pixels of the image that are semantically similar to an image point; and
store each of the masks.

10. The apparatus of claim 9, wherein the at least one processor is configured to:
determine an affinity matrix based on plurality of image features; and
determine an order in which to select the image features based on the affinity matrix;
wherein the image features are selected based on the order.

11. The apparatus of claim 10, wherein the order is determined based on mean similarities of the affinity matrix.

12. The apparatus of claim 9, wherein the at least one processor is configured to accumulate each of the masks to generate a segmentation map of the image.

13. The apparatus of claim 9, wherein, to determine respective image points related to image features, the at least one processor is configured to map the image features to respective grid points.

14. A method for segmenting images, the method comprising:
encoding, using a machine-learning-model image encoder, an image to generate a plurality of image features;
selecting a first image feature from among the plurality of image features;
determining a first image point related to the first image feature;
encoding, using a machine-learning-model prompt encoder, the first image point as a first encoded prompt;
generating, using a machine-learning-model image decoder, a first mask based on the plurality of image features and the first encoded prompt, wherein the first mask is indicative of pixels of the image that are semantically similar to the first image point; and
storing the first mask.

15. The method of claim 14, further comprising determining an affinity matrix based on plurality of image features, wherein the first image feature is selected based on the affinity matrix.

16. The method of claim 15, wherein the affinity matrix is indicative of similarities between each image feature of the plurality of image features.

17. The method of claim 15, wherein the first image feature is selected from among the plurality of image features based on the first image feature having a highest mean similarity of the affinity matrix.

18. The method of claim 14, wherein determining the first image point related to the first image feature comprises mapping the first image feature to a grid point.

19. The method of claim 14, further comprising:
selecting a second image feature from among the plurality of image features;
determining a second image point related to the second image feature;
encoding, using the machine-learning-model prompt encoder, the second image point as a second encoded prompt;
generating, using the machine-learning-model image decoder, a second mask based on the plurality of image features and the second encoded prompt; and
storing the second mask.

20. The method of claim 14, further comprising:
selecting image features from among the plurality of image features;
determining a respective image point related to each image feature of the selected image features;
encoding, using the machine-learning-model prompt encoder, each image point as a respective encoded prompt;
generating, using the machine-learning-model image decoder, a respective mask based on the plurality of image features and each respective encoded prompt of each image point; and
storing each respective mask.

21. (canceled)

22. (canceled)

23. (canceled)

24. (canceled)

25. (canceled)

26. (canceled)
